(19) United States
(12) Patent Application Publication
(10) Pub. No.: US 2026/0159709 A1
(43) Pub. Date: Jun. 11, 2026

(54) UV CURABLE INKS AND COATINGS

(71) Applicant: Sun Chemical Corporation, Parsippany, NJ (US)

(72) Inventors: Ramasamy KRISHNAN, Carlstadt, NJ (US); Mathew MATHEW, Carlstadt, NJ (US); David KLEIN, Carlstadt, NJ (US)

(73) Assignee: Sun Chemical Corporation, Parsippany, NJ (US)

(21) Appl. No.: 18/707,979

(22) PCT Filed: Jan. 18, 2023
(86) PCT No.: PCT/US2023/010986

§ 371 Date: May 7, 2024

Related U.S. Application Data
(60) Provisional application No. 63/300,735, filed on Jan. 19, 2022.

(51) Int. Cl. C09D 11/101; C08K 3/22; C08K 5/07; C09D 4/06; C09D 7/61; C09D 7/63; C09D 11/037

(52) U.S. Cl. CPC C09D 11/101; C08K 3/22; C08K 5/07; C09D 4/06; C09D 7/61; C09D 7/63; C09D 11/037; C08K 2003/2296

(57) ABSTRACT

The present invention provides energy-curable ink and coating compositions comprising a combination of methylbenzoylformate (MBF) and zinc oxide (ZnO). The compositions of the invention cure faster and more thoroughly than compositions comprising MBF alone, even though ZnO alone has no curing effect in this timescale. Using a combination of MBF and ZnO enables the amount of total photoinitiators in the compositions to be reduced.

### CROSS REFERENCE TO RELATED APPLICATIONS

The present application claims priority to U.S. Provisional Application No. 63/300,735, filed 19 Jan. 2022, which is hereby incorporated in its entirety.

### FIELD OF THE INVENTION

The present invention is related to energy-curable inks and coatings with low levels of photoinitiators that, when cured, exhibit improved physical properties. The compositions of the invention comprise ZnO and methylbenzoylformate.

### BACKGROUND OF THE INVENTION

Actinically curable compositions, such as inks, primers, coatings, and adhesives are known in the art. These compositions cure using ultraviolet (UV), and/or electron beam (EB) radiation, with such radiation causing polymerization.

However, to achieve adequate UV cure it is generally necessary to include a photoinitiator in the composition. The use of common photoinitiators has the disadvantage that residues of the photoinitiators may migrate after curing. This is disadvantageous because these migrated residues can contaminate the environment, as well as materials contained with articles comprising the cured compositions, such as food packaging. Most photoinitiators, for example, are classified as toxic substances and compositions that include such photoinitiators may not be suitable for packaging for food, pharmaceutical, cosmetic, personal care items, and the like. In addition, incomplete curing may result in free monomers/oligomers that may result in environmentally toxic moieties.

Kuriacose and Markham described polymerization of methyl methacrylate using zinc oxide (ZnO) as a photoinitiator in dilute aqueous suspensions of ZnO and methyl methacrylate (Joseph C. Kuriacose and M. Clare Markham (1961). Mechanism of the photo-initiated polymerization of methyl methacrylate at zinc oxide surfaces. J. Phys. Chem. 65(12): 2232-2236). Irradiation was conducted at 365 nm, as it was found that radiation above 380 nm is not absorbed by ZnO. They found that when using ZnO as a photocatalyst, surface adsorbed oxygen is necessary to initiate polymerization. However, although oxygen is necessary for initiation, the more oxygen that is present in the polymerization solution, the lower the molecular weight. Too much oxygen in the solution acts as an inhibitor. They compared polymerization in different solvents and found that solvents having high dielectric constants coupled with good proton-donating or hydrogen-bonding characteristics favor chain initiation via excited oxygen on the surface of the ZnO.

Feng and colleagues prepared self-photoinitiated oligomers of water-diluted polyurethane acrylate grafted with 0.1 to 0.3 wt % zinc oxide (ZnO-PUA)) (Jun Feng, Li Fang, Daiyong Ye (2108). Self-photoinitiated oligomers of water-diluted polyurethane acrylate grafted with zinc oxide of low concentrations. Progress in Organic Coatings 120:208-216). They compared the physical properties of cured films of the ZnO-PUA versus films where the ZnO was simply physically mixed with the polyurethane oligomer, but not grafted. Physically mixed ZnO resulted in a harder film surface and higher gloss than chemically grafted ZnO-PUA at the same concentration. However, the film resistance properties were better with the grafted ZnO (ZnO-PUA). They also showed that photoinitiation efficiency of ZnO-PUA is higher than that of Darocure 1173 (2-hydroxy-2-methyl-1-phenyl-propan-1-one) when oxygen is present. The novel oligomers grafted with ZnO can act as photoinitiators. They concluded that the polyurethane and ZnO in the ZnO-PUA work synergistically.

Schmitt tested the ability of different types of ZnO particles to act as a photoinitiator for bulk polymerization of acrylate oligomers (M. Schmitt (2015). Synthesis and testing of ZnO nanoparticles for photo-initiation: experimental observation of two different non-migration initiators for bulk polymerization. Nanoscale 7:9532-9544). Schmitt discloses surface-modified ZnO particles, wherein the particles are modified with various acids (e.g. benzoyl benzoic acid, benzoyl formic acid, levulinic acid), various type I or type II photoinitiators, and Cu(II), Pt(II), Mn(II), and Fe(III). The acid modified ZnO resulted in a slurry in ethanol. Unmodified ZnO did not initiate a polymerization reaction. ZnO particles surface-modified with carboxylic formed fragmenting Type I photoinitiators. Levulinic acid-modified ZnO is described as a Norrish Type I photoinitiator, but is slower by approximately a factor of 10× compared to conventional Norrish Type I photoinitiators. ZnO modified with Cu(II), Pt(II), Mn(II), or Fe(III) forms Norrish Type II photoinitiators, and can initiate polymerization without the addition of a synergist. However, the reaction is much slower than conventional Norrish Type II photoinitiators with a synergist. Schmitt showed that benzoyl benzoic acid modified ZnO particles can be used in printable resins.

Methyl benzoylformate (MBF) is a Norrish Type II photoinitiator (W. Arthur Green (2010). Industrial Photoinitiators: A Technical Guide. CRC Press, Taylor & Francis Group, page 36). The efficiency of Type II photoinitiators is typically enhanced by the addition of amine synergist. However, unlike other Type II photoinitiators, MBF is actually less efficient when a tertiary amine is used as the hydrogen donor.

Citation or identification of any document in this application is not an admission that such represents prior art to the present invention.

### BRIEF SUMMARY OF THE INVENTION

The present invention provides energy-curable ink and coating compositions comprising methylbenzoylformate and zinc oxide (ZnO) that cure quickly and completely, even when no or very low levels of photoinitiators are present.

In a particular aspect, the present invention provides an energy-curable ink or coating composition, comprising:
(a) 1 wt % to 97 wt % one or more energy-curable monomers or oligomers, based on the total weight of the ink or coating composition;
(b) 0.1 wt % to 10 wt % zinc oxide, based on the total weight of the ink or coating composition; and
(c) 0.1 wt % to 20 wt % methylbenzoylformate, based on the total weight of the ink or coating composition.

In certain embodiments, the ink and coating compositions may further comprise one or more photoinitiators. Preferably, the total amount of photoinitiators is less than or equal to 20 wt %, based on the total weight of the ink or coating composition. Preferably, the total amount of photoinitiators is less than or equal to 15 wt %, and more preferably less than or equal to 10 wt %.

In some embodiments, the ink and coating compositions may further comprise one or more colorants. The colorants are typically colorant dispersions, and the dispersions are present in an amount of about 15 wt % to 50 wt %, based on the total weight of the ink or coating compositions.

In certain embodiments, the present invention provides printed substrates comprising an ink or coating of the present invention. In other embodiments, the present invention provides articles that comprise the inks and coatings of the present invention.

These and other objects, advantages, and features of the invention will become apparent to those persons skilled in the art upon reading the details of the formulations and methods as more fully described below.

### DETAILED DESCRIPTION OF THE INVENTION

Applicants have surprisingly discovered that ink and coating compositions comprising the combination of methylbenzoylformate (MBF) with zinc oxide (ZnO) cure faster and more completely than methylbenzoylformate alone.

The advantage to such a system is that it allows for lower levels of photoinitiators, which have been identified as being potentially toxic. Lower photonitiator levels also reduces levels of migratable and extractable species, which is advantageous for all applications, especially packaging applications (e.g. food and personal care packaging, etc.).

It is to be understood that the foregoing general description and the following detailed description are exemplary and explanatory only, and are not restrictive of any subject matter claimed.

Headings are used solely for organizational purposes, and are not intended to limit the invention in any way.

Unless otherwise defined, all technical and scientific terms used herein have the same meaning as is commonly understood by one of skill in the art to which the inventions belong. All patents, patent applications, published applications and publications, websites and other published materials referred to throughout the entire disclosure herein, unless noted otherwise, are incorporated by reference in their entirety for any purpose. Although any methods and materials similar or equivalent to those described herein can be used in the practice or testing of the present invention, the preferred methods are described.

### Definitions

In this application, the use of the singular includes the plural unless specifically stated otherwise. As used herein, the singular forms “a,” “an” and “the” are intended to include the plural forms as well, unless the context clearly indicates otherwise.

In this application, the use of “or” means “and/or” unless stated otherwise. Also, when it is clear from the context in which it is used, “and” may be interpreted as “or,” such as in a list of alternatives where it is not possible for all to be true or present at once.

As used herein, the terms “comprises” and/or “comprising” specify the presence of the stated features, integers, steps, operations, elements, and/or components, but do not preclude the presence or addition of one or more other features, integers, steps, operations, elements, components, and/or groups thereof. Furthermore, to the extent that the terms “includes,” “having,” “has,” “with,” “composed,” “comprised” or variants thereof are used in either the detailed description or the claims, such terms are intended to be inclusive in a manner similar to the term “comprising.”

When the terms “consist of”, “consists of” or “consisting of” is used in the body of a claim, the claim term set off with “consist of”, “consists of” and/or “consisting of” is limited to the elements recited immediately following “consist of”, “consists of” and/or “consisting of”, and is closed to unrecited elements related to that particular claim term. The term ‘combinations thereof’, when included in the listing of the recited elements that follow “consist of”, “consists of” and/or “consisting of” means a combination of only two or more of the elements recited.

As used herein, ranges and amounts can be expressed as “about” a particular value or range. “About” is intended to also include the exact amount. Hence “about 5 percent” means “about 5 percent” and also “5 percent.” “About” means within typical experimental error for the application or purpose intended.

It is to be understood that wherein a numerical range is recited, it includes the end points, all values within that range, and all narrower ranges within that range, whether specifically recited or not.

Throughout this disclosure, all parts and percentages are by weight (wt % or mass % based on the total weight) and all temperatures are in ° C. unless otherwise indicated.

As used herein, “substrate” means any surface or object to which an ink or coating can be applied. Substrates include, but are not limited to, cellulose-based substrates, paper, paperboard, fabric (e.g. cotton), leather, textiles, felt, concrete, masonry, stone, plastic, plastic or polymer film, spunbond non-woven fabrics (e.g. consisting of polypropylene, polyester, and the like) glass, ceramic, metal, wood, composites, combinations thereof, and the like. Substrates may have one or more layers of metals or metal oxides, or other inorganic materials. Particularly preferred are non-woven substrates.

As used herein, the term “article” or “articles” means a substrate or product of manufacture. Examples of articles include, but are not limited to: substrates such as cellulose-based substrates, paper, paperboard, plastic, plastic or polymer film, glass, ceramic, metal, composites, and the like; and products of manufacture such as publications (e.g. brochures), labels, and packaging materials (e.g. cardboard sheet or corrugated board), containers (e.g. bottles, cans), a polyolefin (e.g. polyethylene or polypropylene), a polyester (e.g. polyethylene terephthalate), a metalized foil (e.g. laminated aluminum foil), metalized polyester, a metal container, and the like.

As used herein, “inks and coatings,” “inks,” and “coatings” are used interchangeably, and refer to compositions of the invention, or, when specified, compositions found in the prior art (comparative). Inks and coatings typically contain resins, solvent, and, optionally, colorants. Coatings are often thought of as being colorless or clear, while inks typically include a colorant.

As used herein, “energy-curing” refers to the cure achieved under exposure to various electromagnetic radiation sources producing an actinic effect. Such sources include but are not limited to, electron-beam, UV-light, visible-light, IR, or microwave. Where the compositions are cured under the action of UV light, then non-limiting UV sources such as the following can be used: low pressure mercury bulbs, medium pressure mercury bulbs, a xenon bulb, excimer lamps, a carbon arc lamp, a metal halide bulb, a UV-LED lamp or sunlight. It should be appreciated by those skilled in the art that any UV light source may be used to cure compositions prepared according to the current invention. Compositions of the current invention are especially suited for use in compositions curable under the action of UV light and/or electron-beam.

As used herein, “energy-curable” refers to a composition that can be cured by exposure to one or more types of actinic radiation. Compositions of the current invention are especially suited for use in compositions curable under the action of UV light and/or electron-beam.

As used herein, “(meth)acrylate” and “(meth)acrylic acid” include both acrylate and methacrylate esters, and acrylic and methacrylic acid.

As used herein, “monofunctional” means having one functional group.

As used herein, “multifunctional” means having two or more functional groups. A multifunctional monomer, for example, can be di-functional, tri-functional, tetra-functional, or have a higher number of functional groups. The two or more functional groups can be the same or different.

As used herein, “monomer” refers to a small molecule having one or more functional groups. Monomers react with other monomers, either the same or different, to form monomer chains (oligomers and/or polymers). Each monomer in a chain is a monomer repeating unit. A monomer is the smallest unit that makes up an oligomer or a polymer. A monomer is a low molecular weight molecule, usually less than or equal to 100 Daltons weight average molecular weight (Mw).

As used herein, “oligomer” refers to a chain of a few monomer repeating units. Oligomers are a few to several monomer units long chains, and have a mid-range weight average molecular weight of about 100 Daltons to about 10,000 Daltons.

As used herein, “polymer” refers to a large molecule, containing multiple monomer and/or oligomer repeating units. Polymers are high molecular weight molecules, having a weight average molecular weight of greater than about 10,000 Daltons.

As used herein, the terms “Norrish Type I photoinitiator” and “Type I photoinitiator” are used interchangeably.

As used herein, the terms “Norrish Type II photoinitiator” and “Type II photoinitiator” are used interchangeably.

### Ink and Coating Compositions

The present invention is the first time that it has been shown that using a combination of MBF and ZnO in an energy-curable composition produces a synergistic effect in curing.

Although ZnO can be used as a photoinitiator under certain conditions, unmodified ZnO is generally very inefficient, requiring relatively high doses of radiation, and long reaction times. Or, in some instances, surface-modified ZnO results in polymerization, while no reaction is observed when unmodified ZnO is used.

The ink and coating compositions of the invention comprise one or more ethylenically unsaturated monomers and/or oligomers. Typically, the compositions comprise about 1 wt % to about 97 wt % monomers/oligomers, based on the total weight of the ink or coating composition. For example, the ink or coating composition may comprise about 1 wt % to about 90 wt % monomers/oligomers, based on the total weight of the ink or coating composition; or about 5 wt % to about 90 wt % or about 5 wt % to about 80 wt %; or about 5 wt % to about 50 wt %; or about 10 wt % to about 90 wt %; or about 10 wt % to about 80 wt %; or about 20 wt % to about 90 wt %; or about 20 wt % to about 80 wt %. Preferably, the ink and coating compositions comprise about 40 wt % to about 65 wt % monomers/oligomers, based on the total weight of the ink or coating composition.

Examples of suitable monofunctional ethylenically unsaturated monomers include, but are not limited, to the following: isobutyl acrylate; cyclohexyl acrylate; iso-octyl acrylate; n-octyl acrylate; isodecyl acrylate; iso-nonyl acrylate; octyl/decyl acrylate; lauryl acrylate; 2-propyl heptyl acrylate; tridecyl acrylate; hexadecyl acrylate; stearyl acrylate; iso-stearyl acrylate; behenyl acrylate; tetrahydrofurfuryl acrylate; 4-t.butyl cyclohexyl acrylate; 3,3,5-trimethylcyclohexane acrylate; isobornyl acrylate; dicyclopentyl acrylate; dihydrodicyclopentadienyl acrylate; dicyclopentenyloxyethyl acrylate; dicyclopentanyl acrylate; benzyl acrylate; phenoxyethyl acrylate; 2-hydroxy-3-phenoxypropyl acrylate; alkoxylated nonylphenol acrylate; cumyl phenoxyethyl acrylate; cyclic trimethylolpropane formal acrylate; 2 (2-ethoxyethoxy)ethyl acrylate; polyethylene glycol monoacrylate; polypropylene glycol monoacrylate; caprolactone acrylate; ethoxylated methoxy polyethylene glycol acrylate; methoxy triethylene glycol acrylate; tripropyleneglycol monomethyl ether acrylate; diethyleneglycol butyl ether acrylate; alkoxylated tetrahydrofurfuryl acrylate; ethoxylated ethyl hexyl acrylate; alkoxylated phenol acrylate; ethoxylated phenol acrylate; ethoxylated nonyl phenol acrylate; propoxylated nonyl phenol acylate; polyethylene glycol o-phenyl phenyl ether acrylate; ethoxylated p-cumyl phenol acrylate; ethoxylated nonyl phenol acrylate; alkoxylated lauryl acrylate; ethoxylated tristyrylphenol acrylate; N-(acryloyloxyethyl) hexahydrophthalimide; N-butyl 1,2 (acryloyloxy) ethyl carbamate; acryloyl oxyethyl hydrogen succinate; octoxypolyethylene glycol acrylate; octafluoropentyl acrylate; 2-isocyanato ethyl acrylate; acetoacetoxy ethyl acrylate; 2-methoxyethyl acrylate; dimethyl aminoethyl acrylate; 2-carboxyethyl acrylate; 4-hydroxy butyl acrylate; combinations thereof, and the like. As used herein, the term ethoxylated refers to chain extended compounds through the use of ethylene oxide, propoxylated refers to chain extended compounds through the use of propylene oxide, and alkoxylated refers to chain extended compounds using either or both ethylene oxide and propylene oxide. Equivalent methacrylate compounds are also capable of being used, although those skilled in the art will appreciate that methacrylate compounds have lower reactivity than their equivalent acrylate counterparts.

Examples of suitable multifunctional ethylenically unsaturated monomers include but are not limited to the following: 1,3-butylene glycol diacrylate; 1,4-butanediol diacrylate; neopentyl glycol diacrylate; ethoxylated neopentyl glycol diacrylate; propoxylated neopentyl glycol diacrylate; 2-methyl-1,3-propanediyl ethoxy acrylate; 2-methyl-1,3-propanediol diacrylate; ethoxylated 2-methyl-1,3-propanediol diacrylate; 3 methyl 1,5-pentanediol diacrylate; 2-butyl-2-ethyl-1,3-propanediol diacrylate; 1,6-hexanediol diacrylate; alkoxylated hexanediol diacrylate; ethoxylated hexanediol diacrylate; propoxylated hexanediol diacrylate; 1,9-nonanediol diacrylate; 1,10 decanediol diacrylate; ethoxylated hexanediol diacrylate; alkoxylated hexanediol diacrylate; diethyleneglycol diacrylate; triethylene glycol diacrylate; tetraethylene glycol diacrylate; polyethylene glycol diacrylate; propoxylated ethylene glycol diacrylate; dipropylene glycol diacrylate; tripropyleneglycol diacrylate; polypropylene glycol diacrylate; poly (tetramethylene glycol) diacrylate; cyclohexane dimethanol diacrylate; ethoxylated cyclohexane dimethanol diacrylate; alkoxylated cyclohexane dimethanol diacrylate; polybutadiene diacrylate; hydroxypivalyl hydroxypivalate diacrylate; tricyclodecanedimethanol diacrylate; 1,4-butanediylbis [oxy(2-hydroxy-3,1-propanediyl)]diacrylate; ethoxylated bisphenol A diacrylate; propoxylated bisphenol A diacrylate; propoxylated ethoxylated bisphenol A diacrylate; ethoxylated bisphenol F diacrylate; 2-(2-vinyloxyethoxy)ethyl acrylate; dioxane glycol diacrylate; ethoxylated glycerol triacrylate; glycerol propoxylate triacrylate; pentaerythritol triacrylate; trimethylolpropane triacrylate; caprolactone modified trimethylol propane triacrylate; ethoxylated trimethylolpropane triacrylate; propoxylated trimethylol propane triacrylate; tris (2-hydroxy ethyl) isocyanurate triacrylate; e-caprolactone modified tris (2-hydroxy ethyl) isocyanurate triacrylate; melamine acrylate oligomer; pentaerythritol tetraacrylate; ethoxylated pentaerythritol tetraacrylate; di-trimethylolpropane tetra acrylate; dipentaerythritol pentaacrylate; dipentaerythritol hexaaacrylate; ethoxylated dipentaerythritol hexaacrylate; combinations thereof, and the like. The term ethoxylated refers to chain extended compounds through the use of ethylene oxide, propoxylated refers to chain extended compounds through the use of propylene oxide, and alkoxylated refers to chain extended compounds using either or both ethylene oxide and propylene oxide. Equivalent methacrylate compounds are also capable of being used, although those skilled in the art will appreciate that methacrylate compounds have lower reactivity than their equivalent acrylate counterparts.

Other functional monomer classes capable of being used in part in these formulations include cyclic lactam such as N-vinyl caprolactam; N-vinyl oxazolidinone and N-vinyl pyrrolidone, and secondary or tertiary acrylamides such as N-acryloyl morpholine; diacetone acrylamide; N-methyl acrylamide; N-ethyl acrylamide; N-isopropyl acrylamide; N-t-butyl acrylamide; N-hexyl acrylamide; N-cyclohexyl acrylamide; N-octyl acrylamide; N-t-octyl acrylamide; N-dodecyl acrylamide; N-benzyl acrylamide; N-(hydroxymethyl) acrylamide; N-isobutoxymethyl acrylamide; N-butoxymethyl acrylamide; N,N-dimethyl acrylamide; N,N-diethyl acrylamide; N,N-propyl acrylamide; N,N-dibutyl acrylamide; N,N-dihexyl acrylamide; N,N-dimethylamino methyl acrylamide; N,N-dimethylamino ethyl acrylamide; N,N-dimethylamino propyl acrylamide; N,N-dimethylamino hexyl acrylamide; N,N-diethylamino methyl acrylamide; N,N-diethylamino ethyl acrylamide; N,N-diethylamino propyl acrylamide; N,N-dimethylamino hexyl acrylamide; and N,N′-methylenebisacrylamide.

Other ethylenically unsaturated polymerizable compounds include, but are not limited to, urethane acrylates, epoxy acrylates, and combinations thereof.

The compositions of the present invention comprise unmodified zinc oxide (ZnO). Typically, the compositions of the present invention comprise about 0.1 wt % to about 10 wt % ZnO, based on the total weight of the composition. For example, the compositions may comprise ZnO in an amount of about 0.1 wt % to about 5 wt %; or about 0.1 wt % to about 1 wt %; or about 0.1 wt % to about 0.5 wt %. Preferably, the compositions of the present invention comprise about 0.1 wt % to about 3 wt % ZnO, and most preferably, about 1 wt % to about 2 wt % ZnO.

The compositions of the present invention comprise methylbenzoylformate (MBF). Typically, the compositions of the present invention comprise about 0.1 wt % to about 20 wt % methylbenzoylformate, based on the total weight of the composition. For example, the compositions may comprise methylbenzoylformate in an amount of about 0.1 wt % to about 15 wt %; or about 0.1 wt % to about 10 wt %; or about 0.1 wt % 5 to about 5 wt %; or 0.1 wt % to about 1 wt %; or about 0.1 wt % to about 0.5 wt %. Preferably, the compositions of the present invention comprise about 0.1 wt % to about 15 wt % methylbenzoylformate. And most preferably, the compositions of the invention comprise about 4 wt % to about 8 wt % methylbenzoylformate.

Typically, the mole ratio of ZnO:MBF is about 0.1:1.5 to 1:1. Preferably, the mole ratio of ZnO:MBF is about 0.1:1.5 to 0.5:1.0.

The present invention is the first time that MBF and ZnO were used together as a photoinitiator component at these levels and these ratios. The combination resulted in compositions that cured faster, and achieved more complete cure. The improvement in cure was synergistic, not merely additive. This is unexpected in view of the prior art. This can be seen in the examples below, where inventive compositions cured faster, i.e. fewer passes of energy curing radiation, than comparative examples. The more complete cure is demonstrated in the resistance to removal by isopropanol (IPA) or methylethylketone (MEK) rubs of the inventive compositions compared to the comparative compositions. These advantages are demonstrated for both colored compositions and clear coatings.

The compositions of the present invention optionally comprise one or more additional photoinitiators. When present, the compositions of the present invention typically comprise about 0.1 wt % to about 20 wt % total photoinitiators (MBF+additional photoinitiators), based on the total weight of the composition. Preferably, the total amount of photoinitiators is less than or equal to 15 wt %, based on the total weight of the ink or coating composition. More preferably, the total amount of photoinitiators is less than or equal to 12 wt %, and most preferably less than or equal to 10 wt %.

Photoinitiators are chemicals that absorb energy upon exposure to actinic radiation (e.g. UV light, electron beam, etc.). Currently, the two most common types of chemistry for energy curing are free radical and cationic. Free radical photoinitiators produce reactive radicals upon exposure to actinic radiation. Acrylates are the most common type of polymerizable compound used in free radical curing systems. Cationic curing involves the production of a an acid upon exposure of a cationic photoinitiator to actinic radiation, and the proton that is generated will open rings such as epoxys, oxetanes, etc. and initiate a ring opening polymerization process. For the purposes of the present invention, free radical curing is of the most interest.

Free radical photoinitiators are classified into one of two main groups, depending on what type of reactive species is formed, Norrish type I and Norrish type II. Norrish type I photoinitiators are cleavage type photoinitiators, wherein actinic radiation exposure leads to hemolytic bond cleavage and generation of two reactive fragments of the photoinitiator. Norrish type II photoinitiators are hydrogen abstraction, and need a hydrogen donor to react. Synergists, such as amines, are generally used in combination with Norrish type II photoinitiators as the source of the hydrogen donor. The type II photoinitiator abstracts a hydrogen atom from the synergist, forming two radicals.

There is no restriction on the type, blend or concentration of photoinitiator used and can include any suitable type of photoinitiators, such as, but not limited to: α-hydroxyketones, acyl phosphine oxides, α-aminoketones, thioxanthones, benzophenones, phenylglyoxylates, oxime esters, and combinations thereof.

Suitable α-hydroxyketones include, but are not limited to: 1-hydroxy-cyclohexyl-phenyl-ketone; 2-hydroxy-2-methyl-1-phenyl-1-propanone; 2-hydroxy-2-methyl-4′-tert-butyl-propiophenone; 2-hydroxy-4′-(2-hydroxyethoxy)-2-methyl-propiophenone; 2-hydroxy-4′-(2-hydroxypropoxy)-2-methyl-propiophenone; oligo 2-hydroxy-2-methyl-1-[4-(1-methyl-vinyl)phenyl]propanone; bis [4-(2-hydroxy-2-methylpropionyl)phenyl]methane; 2-hydroxy-1-[1-[4-(2-hydroxy-2-methylpropanoyl)phenyl]-1,3,3-trimethylindan-5-yl]-2-methylpropan-1-one; 2-hydroxy-1-[4-[4-(2-hydroxy-2-methylpropanoyl) phenoxy]phenyl]-2-methylpropan-1-one; and combinations thereof.

Suitable acylphosphine oxides include, but are not limited to: 2,4,6-trimethylbenzoyl-diphenylphosphine oxide; ethyl-(2,4,6-trimethylbenzoyl) phenyl phosphinate; bis-(2,4,6-trimethylbenzoyl)-phenylphosphine oxide; and combinations thereof.

Suitable α-aminoketones include, but are not limited to: 2-methyl-1-[4-methylthio)phenyl]-2-morpholinopropan-1-one; 2-benzyl-2-dimethylamino-1-(4-morpholinophenyl)-butan-1-one; 2-dimethylamino-2-(4-methyl-benzyl)-1-(4-morpholin-4-yl-phenyl)-butan-1-one; and combinations thereof.

Suitable thioxanthones include, but are not limited to: 2-4-diethylthioxanthone, isopropylthioxanthone, 2-chlorothioxanthone, and 1-chloro-4-propoxythioxanthone; and combinations thereof.

Suitable benzophenones include, but are not limited to: benzophenone, 4-phenylbenzophenone, and 4-methylbenzophenone; methyl-2-benzoylbenzoate; 4-benzoyl-4-methyldiphenyl sulphide; 4-hydroxybenzophenone; 2,4,6-trimethyl benzophenone, 4,4-bis(diethylamino)benzophenone; benzophenone-2-carboxy (tetraethoxy) acrylate; 4-hydroxybenzophenone laurate; 1-[-4-[benzoylphenylsulpho]phenyl]-2-methyl-2-(4-methylphenylsulphonyl) propan-1-one; and combinations thereof.

Suitable phenylglyoxylates include, but are not limited to: phenyl glyoxylic acid methyl ester; oxy-phenyl-acetic acid 2-[hydroxyl-ethoxy]-ethyl ester; oxy-phenyl-acetic acid 2-[2-oxo-2-phenyl-acetoxy-ethoxy]-ethyl ester; and combinations thereof.

Suitable oxime esters include, but are not limited to: 1-phenyl-1,2-propanedione-2-(O-ethoxycarbonyl) oxime; [1-(4-phenylsulfanylbenzoyl)heptylideneamino]benzoate; [1-[9-ethyl-6-(2-methylbenzoyl) carbazol-3-yl]-ethylideneamino]acetate; and combinations thereof.

Examples of other suitable photoinitiators include diethoxy acetophenone; benzil; benzil dimethyl ketal; titanocen radical initiators such as titanium-bis(η 5-2,4-cyclopentadien-1-yl)-bis-[2,6-difluoro-3-(1H-pyrrol-1-yl)phenyl]; 9-fluorenone; camphorquinone; 2-ethyl anthraquinone; and the like.

An amine synergist, may also optionally be included in the formulation. Suitable examples include, but are not limited to: aromatic amines, such as 2-(dimethylamino)ethylbenzoate; N-phenyl glycine; benzoic acid, 4-(dimethylamino)-, 1,1′-[(methylimino)di-2,1-ethanediyl]ester; and simple alkyl esters of 4-(N,N-dimethylamino)benzoic acid and other positional isomers of N,N-dimethylamino)benzoic acid esters, with ethyl, amyl, 2-butoxyethyl and 2-ethylhexyl esters being particularly preferred; aliphatic amines, such as such as N-methyldiethanolamine, triethanolamine and tri-isopropanolamine; aminoacrylates and amine modified polyether acrylates, such as EBECRYL 80, EBECRYL 81, EBECRYL 83, EBECRYL 85, EBECRYL 880, EBECRYL LEO 10551, EBECRYL LEO 10552, EBECRYL LEO 10553, EBECRYL 7100, EBECRYL P115 and EBECRYL P116 available from ALLNEX; CN501, CN550, CN UVA421, CN3705, CN3715, CN3755, CN381 and CN386, all available from Sartomer; GENOMER 5142, GENOMER 5161, GENOMER 5271 and GENOMER 5275 from RAHN; PHOTOMER 4771, PHOTOMER 4967, PHOTOMER 5006, PHOTOMER 4775, PHOTOMER 5662, PHOTOMER 5850, PHOTOMER 5930, and PHOTOMER 4250 all available from IGM, LAROMER LR8996, LAROMER LR8869, LAROMER LR8889, LAROMER LR8997, LAROMER PO 83F, LAROMER PO 84F, LAROMER PO 94F, LAROMER PO 9067, LAROMER PO 9103, LAROMER PO 9106 and LAROMER PO77F, all available from BASF; AGISYN 701, AGISYN 702, AGISYN 703, NeoRad P-81 and NeoRad P-85 all available from DSM-AGI.

Polymeric photoinitiators and sensitizers are also suitable, including, for example, polymeric aminobenzoates (GENOPOL AB-1 or AB-2 from RAHN; Omnipol ASA from IGM or Speedcure 7040 from Lambson), polymeric benzophenone derivatives (GENOPOL BP-1 or BP-2 from RAHN; Omnipol BP, Omnipol BP2702 or Omnipol 682 from IGM or Speedcure 7005 from Lambson); polymeric thioxanthone derivatives (GENOPOL TX-1 or TX-2 from RAHN, Omnipol TX from IGM or Speedcure 7010 from Lambson); polymeric aminoalkylphenones such as Omnipol 910 from IGM; polymeric benzoyl formate esters such as Omnipol 2712 from IGM; and the polymeric sensitizer Omnipol SZ from IGM.

The ink and coating compositions of the present invention may further comprise one or more colorants. When present, the ink and coating compositions comprise about 1 wt % to 60 wt % one or more colorants, based on the total weight of the ink or coating composition. For example, the colorants may be present in an amount of about 1 wt % to about 30 wt %, based on the total weight of the ink or coating composition; or about 1 wt % to about 10 wt %; or about 10 wt % to about 60 wt %; or about 10 wt % to about 30 wt %.

Suitable colorants include, but are not limited to organic or inorganic pigments and dyes. The dyes include but are not limited to azo dyes, anthraquinone dyes, xanthene dyes, azine dyes, combinations thereof and the like. Organic pigments may be one pigment or a combination of pigments, such as for instance Pigment Yellow Numbers 12, 13, 14, 17, 74, 83, 114, 126, 127, 138, 150, 155, 174, 180, 181, 188; Pigment Red Numbers 2, 22, 23, 48:1, 48:2, 52, 52:1, 53, 57:1, 112, 122, 166, 170, 176, 184, 202, 254, 266, 269; Pigment Orange Numbers 5, 16, 34, 36; Pigment Blue Numbers 15, 15:3, 15:4; Pigment Violet Numbers 3, 19, 23, 27; and/or Pigment Green Number 7. Inorganic pigments may be one of the following non-limiting pigments: iron oxides, titanium dioxides, chromium oxides, ferric ammonium ferrocyanides, ferric oxide blacks, Pigment Black Number 7 and/or Pigment White Numbers 6 and 7. Other organic and inorganic pigments and dyes can also be employed, as well as combinations that achieve the colors desired.

The inks and coatings of the present invention may further comprise one or more additives. Suitable additives include, but are not limited to, adhesion promoters, silicones, light stabilizers, optical brighteners, de-gassing additives, ammonia, flow promoters, defoamers, antioxidants, stabilizers, surfactants, dispersants, plasticizers, rheological additives, waxes, silicones, flattening agents, and combinations thereof. When present, the additives are each individually present in an amount of about 0.1 wt % to about 5 wt %, based on the total weight of the composition.

The ink and coating compositions of the present invention may further comprise one or more solvents. Suitable solvents include, but are not limited to, water, alcohols, aliphatic hydrocarbons, cyclic hydrocarbons, aromatic hydrocarbons, ketones, aldehydes, ethers, esters, and combinations thereof. When present, the total amount of solvents is typically 0.1 wt % to 10 wt %, based on the total weight of the composition. Solvents may be added solvents, or they may be present as part of one of the materials used, for e.g. solvents may be present in a pigment dispersion that is added to the ink or coating composition.

### Examples

The present invention is further described by the following non-limiting examples, which further illustrate the invention, and are not intended to, nor should they be interpreted to, limit the scope of the invention.

### Materials

PPTTA—ethoxylated (5.0) pentaerythritol tetra-acrylate (BASF).
Photomer Aqua 6902—water dilutable urethane acrylate (IGM Resins)

BYK 9077—polyglycol polyester modified polyalkylene imine (solvent-free wetting and dispersing additive; BYK)
ZnO—zinc oxide, Grade 102 (from Zochem)
Omnirad MBF—methylbenzoylformate (photoinitiator; IGM Resins)
Cyan dispersion R4261-144A—35% pigment in monomer
TMPTA—trimethylolpropane triacrylate
TRPGDA—tripropyleneglycol diacrylate
Radsol ICS-41—inhibitor (Rad-Solutions, LLC
Foamblast UVD—100% active silicone/silica concentrate foam control agent (DyStar)
Ebecryl 9372—acrylate (Allnex/Sun Chemical)
Genomer 5161—acrylated amine (Rahn)
Ebecryl 40—tetrafunctional polyether acrylate (Allnex)
Omnirad 1173—2-hydroxy-2-methyl-1-phenylpropanone (photoinitiator; IGM Resins)
Omnirad OMBB—methyl-o-benzoylbenzoate (photoinitiator; IGM Resins)
Omnirad 184—1-hydroxycyclohexyl-phenyl ketone (photoinitiator; IGM Resins)
MP Bright 100—optical brightener (MPI Chemie) Acematt OK412—flattening agent (Evonik)
B-122—wax (United-Guardian, Inc.)
Erbeck One—Product #01-1 silicone additive (Erbeck One)
Tego Rad 2250—silicone acrylate (Evonik)

### Methods

### Preparation of Ink and Coating Compositions

Inks and coatings were prepared by mixing the ingredients using laboratory DAC 150 FVZ speed mixer at 3000 RPM for 2-4 minutes at room temperature.

### Printing of Inks

Prints of inks were made on bi-axially oriented polypropylene (BOPP) using a 3.1 BCM anilox roller and cured using a laboratory UV unit at 120 mJ/cm².

### Application of Coatings

Coating was applied on Leneta chart (form N2A-3) using a 10 BCM anilox roller and cured using laboratory UV unit at 200 FPM/400 watts (200 mJ/cm²).

### Isopropanol (IPA) Rub Resistance

The cured film was tested for IPA rub resistance by rubbing the surface of the cured film with a cotton pad soaked with IPA until failure or breakthrough of the film. The rubs were counted as double rub (one rub forward and one rub backward constitutes one double rub). In the test, a cotton swab was dipped into IPA and double rubs were performed on the surface of the substrate coated with the ink/coating until the ink/coating began to break. Results were recorded as the number of double rubs it took to break the cured film. A minimum of 10 rubs was required to be considered to be an acceptable rub resistance.

### Methyl Ethyl Ketone (MEK) Rub Resistance

A cotton applicator (holding the applicator at the top like a pencil) or cotton ball was dipped in MEK, and double rubs were performed until the film was completely broken. Results were recorded as the number of double rubs it took to break the cured film. A minimum of 10 rubs was required to be considered to be an acceptable rub resistance.

### Gloss

Gloss of the cured was measured using a BYK Gardner 60° Gloss Meter.

### Viscosity

Viscosity was tested using an AR-1000 cone and plate at 100 s⁻¹.

### Examples 1 to 5. Preparation and Testing of Colored Inks

Cyan inks were prepared as described above. The formulations of the cyan inks, are shown in Table 1. The amounts are wt %, based on the total weight of the composition. Examples 1 and 2 are comparative cyan inks. Examples 3 to 5 are compositions of the present invention.

The printed and cured inks were tested as described. The test results are shown in Table 1.

TABLE 1
Cyan inks: Comparative Examples 1-2; Inventive Examples 3-5

| | | | Ex. 3 | Ex. 4 | Ex. 5 |
|---|---|---|---|---|---|
| | Ex. 1 | Ex. 2 | (Inv.) | (Inv.) | (Inv.) |
| | (Comp.) | (Comp.) | R4343- | R4343- | R4343- |
| | R4343- | R4343- | 24B-1 | 24C | 23A |
| | 24A | 24B | 2% MBF/ | 2% ZnO/ | 2% ZnO/ |
| | 2% ZnO | 2% MBF | 1% ZnO | 1% MBF | 2% MBF |
| PPTTA | 57.00 | 57.00 | 56.00 | 56.00 | 55.00 |
| Photomer | 10.00 | 10.00 | 10.00 | 10.00 | 10.00 |
| Aqua 6902 | | | | | |
| BYK 9077 | 1.00 | 1.00 | 1.00 | 1.00 | 1.00 |
| ZnO | 2.00 | X | 1.00 | 2.00 | 2.00 |
| Methyl | X | 2.00 | 2.00 | 1.00 | 2.00 |
| benzoyl | | | | | |
| formate | | | | | |
| (MBF) | | | | | |
| Cyan | 30.00 | 30.00 | 30.00 | 30.00 | 30.00 |
| Dispersion | | | | | |
| R4261-144A | | | | | |
| Total | 100.00 | 100.00 | 100.00 | 100.00 | 100.00 |
| ¹Ink | | 3-4 | 2-3 | | 3 |
| cure/Passes | | | | | |
| IPA Rubs | | 10 | 50 | | 40 |
| MEK Rubs | | 4 | 18 | | |

The number of UV passes required to cure Examples 1-5.

The results in Table 1 show that the combination of MBF and ZnO provides effective cure without the need for further photoinitiators. Inventive Examples 3 and 5 showed the most improvement over the Comparative Examples 1 and 2. Furthermore, the data show that compositions comprising MBF/ZnO combination cure faster and more thoroughly, even though ZnO alone has no curing effect in this timescale. This suggests that the effect of MBF and ZnO is synergistic, not merely additive.

### Examples 6 to 8. Clear Coatings with Additional Photoinitiators Vs MBF/ZnO

The formulations of Examples 6 to 8 are shown in Table 3 below. Comparative Example 6 is a clear coating comprising additional photoinitiators, but no MBF/ZnO. Inventive Examples 7 and 8 are clear coatings prepared with MBF/ZnO, but no additional photoinitiators. The clear coatings were tested as described above. The results are shown in Table 2.

TABLE 2
Clear coatings: Examples 6 to 8

| | | Ex. 7 | Ex. 8 |
|---|---|---|---|
| | | (Inv.) | (Inv.) |
| | Ex. 6 | R4290- | R4290- |
| | (Comp.) | 139-A | 140-A |
| TMPTA | 21.94 | 29.00 | 28.00 |
| TRPGDA | 13.01 | 13.00 | 15.80 |
| Inhibitor | 0.30 | 0.30 | 0.30 |
| Foamblast UVD | 1.00 | 1.00 | 1.00 |
| Ebecryl 9372 | 23.00 | 31.25 | 30.45 |
| Genomer 5161-Amine | 13.50 | 0.00 | 0.00 |
| Acrylate | | | |
| Ebecryl 40 | 7.00 | 7.00 | 7.00 |
| Omnirad 1173 | 1.80 | 0.00 | 0.00 |
| OMBB | 6.00 | 0.00 | 0.00 |
| Omnirad 184 | 1.00 | 0.00 | 0.00 |
| OB | 0.10 | 0.10 | 0.10 |
| Flattening agent | 3.05 | 3.05 | 3.05 |
| Wax | 6.00 | 6.00 | 6.00 |
| Erbeck One | 2.00 | 2.00 | 2.00 |
| Tego Rad 2250 | 0.30 | 0.30 | 0.30 |
| ZnO | 0.00 | 2.00 | 1.00 |
| Omnirad MBF | 0.00 | 4.00 | 4.00 |
| Byk 9077 | 0.00 | 1.00 | 1.00 |
| Total | 100 | 100 | 100 |
| Viscosity @ 100 s − 1 | 301 cps | 475 cps | 287 cps |
| 60° gloss (20-25) | 30.8 | 30.1 | 28.7 |
| MEK Double Rubs >= 15 | 23 | 93 | 80 |

The results in Table 3 show that the three photoinitiators in Comparative Example 6 (Omnirad 1173, OMBB, and Omnirad 184; with a total photoinitiator content of 8.8%) can be replaced with ZnO and Omnirad MBF in Inventive Examples 7 and 8, with the photoinitiator content reduced to 4% (MBF), while still exhibiting improved MEK rub resistance. Thus, improved curing results can be achieved with the MBF/ZnO combination, without the need for any additional photoinitiators.

The present invention has been described in detail, including the preferred embodiments thereof. However, it will be appreciated that those skilled in the art, upon consideration of the present disclosure, may make modifications and/or improvements on this invention that fall within the scope and spirit of the invention.

What is claimed:

1. An energy-curable ink or coating composition, comprising:
(a) 1 wt % to 97 wt % one or more energy-curable monomers or oligomers, based on the total weight of the ink or coating composition;
(b) 0.1 wt % to 10 wt % zinc oxide, based on the total weight of the ink or coating composition; and
(c) 0.1 wt % to 20 wt % methylbenzoylformate, based on the total weight of the ink or coating composition.

2. The energy-curable ink or coating composition of claim 1, further comprising one or more additional photoinitiators, wherein the total photoinitiator content is less than or equal to 20 wt %, based on the total weight of the ink or coating composition.

3. The energy-curable ink or coating composition of claim 2, wherein the total photoinitiator content is less than or equal to 15 wt %, based on the total weight of the ink or coating composition.

4. The energy-curable ink or coating composition of claim 2, wherein the total photoinitiator content is less than or equal to 10 wt %, based on the total weight of the ink or coating composition.

5. The energy-curable ink or coating composition of claim 1, further comprising one or more colorants.

6. The energy-curable ink or coating composition of claim 1, comprising 0.1 wt % to 3 wt % ZnO.

7. The energy-curable ink or coating composition of claim 1, comprising 0.1 wt % to 15 wt % MBF.

8. The energy-curable ink or coating composition of claim 1, wherein, when printed on a substrate and cured to obtain a cured film, the cured film withstands equal to or greater than 10 isopropanol double rubs and/or methyl ethyl ketone double rubs.

9. A substrate comprising the energy-curable ink or coating composition of claim 1.

10. An article comprising the substrate of claim 9.
